(19) United States
(12) Patent Application Publication
(10) Pub. No.: US 2005/0135393 A1
(43) Pub. Date: Jun. 23, 2005

(54) Peripheral hub for mobile phones

(76) Inventors: David S. Benco, Winfield, IL (US); Sanjeev Mahajan, Naperville, IL (US)

Correspondence Address: PATTI & BRILL, ONE NORTH LASALLE STREET, 44TH FLOOR, CHICAGO, IL, 60602, US

(21) Appl. No.: 10/742,154

(22) Filed: Dec. 19, 2003

(51) Int. Cl. H04L 12/28

(52) U.S. Cl. 370/408

(57) ABSTRACT

Embodiments of the method and system provide a system that provides for interfacing a data capable mobile phone to peripheral devices. The system may have: an internal bus in the mobile phone; a peripheral hub operatively connected to the internal bus; a plurality of peripheral devices operatively connected to the peripheral hub; and the peripheral hub respectively functionally coupling the peripheral devices to the mobile phone. The method is implemented by the system.

### TECHNICAL FIELD

The present invention relates to wireless telephony in general, and, more particularly, to a method and system that provides an interface for a data capable mobile phone. The interface provides an operable connection between the mobile phone and an external peripheral device, such as a keyboard, mouse, monitor, printer, etc.

### BACKGROUND OF THE INVENTION

The general concept of connection of external peripheral devices to a computer is well known. Portable computers, such as notebook computers and laptop computers, are popular and widespread devices that provide a user with mobile computing power in a small, lightweight portable package. Although portable computers are very efficient mobile computing devices, they also can be used in non-mobile computing environments. For example, one common device that enables a user to use a portable computer as a “replacement” for a desktop computer is a docking platform. A docking platform (such as a docking station or a port replicator) facilitates the use of a portable computer with components that are usually considered non-portable and associated with the desktop computer system, such as desktop computer peripherals and network connections.

Docking platforms are typically used to interface portable computers to other portable, desktop or non-portable electronic peripherals, such as computer monitors, optical disk drives, full-size keyboards, pointing devices such as trackballs or mice, digital cameras, and other devices. Many types and styles of docking stations have been developed to interface with portable computers.

The current generation of mobile phones (also referred to as mobile handsets, mobile terminals, personal data assistances, etc.) supports packet data wireless access. With growing acceptance of mobile data applications and growing complexity of data capable mobile phones it is feasible that users may eventually want to use the data capable mobiles as computing platforms. When the data capable mobile phones are used as computing platforms, many applications are feasible, such as sharing, with an audience, a presentation off a company intranet or downloaded to the data capable mobile phone. This would be greatly facilitated if the data capable mobiles could connect to external audio/visual/data peripheral devices much like a personal computer. However, current mobile phones are unable to interface with external peripheral devices.

Thus, there is a need for an interface that is an operable connection between the mobile phone and an external peripheral device, such as a keyboard, mouse, monitor, printer, etc.

### SUMMARY

The following summary of embodiments of the invention is provided to facilitate an understanding of some of the innovative features unique to the present invention and is not intended to be a full description. A full appreciation of the various aspects of the invention can be gained by taking the entire specification, claims, drawings, and abstract as a whole.

In general terms, an embodiment of the present system is a system that provides for interfacing a data capable mobile phone to peripheral devices. This embodiment of the system may have: an internal bus in the mobile phone; a peripheral hub operatively connected to the internal bus, the peripheral hub having I/O ports; a plurality of peripheral devices operatively connected to the I/O ports of the peripheral hub; device controllers in the peripheral hub for respectively the I/O ports; and the peripheral hub respectively functionally coupling the peripheral devices to the mobile phone.

In another embodiment the peripheral hub may have: an input operatively connectable to an internal bus of the mobile phone; an input that is an I/O port operatively connectable to an internal bus of the mobile phone; at least one peripheral device output that is an I/O port; a functionality module operatively connected to the input and to the at least one peripheral device output, the functionality module having I/O interface device controllers for the I/O ports; wherein the functionality module separates at least one peripheral interface from the internal bus of the mobile phone and makes the at least one peripheral interface available on the at least one output.

In a further embodiment of a system for interfacing a data capable mobile phone to at least one peripheral device, the system may have: an internal bus in the mobile phone; a bus connector on the mobile phone, the bus connector operatively connected to the internal bus; a peripheral hub having an input that is an I/O port and at least one output that is an I/O port; an interface cable having a first end releasably connectable to the bus connector and a second end operatively connected to the input of the peripheral hub; at least one peripheral device releasably connectable to the at least one output of the peripheral hub; and a functionality module operatively connected to the input and to the at least one output, the functionality module having I/O interface device controllers separating at least one peripheral interface from the internal bus of the mobile phone and making the at least one peripheral interface available on the at least one output.One embodiment of the present method for interfacing a data capable mobile phone to at least one peripheral device, may have the steps of: providing a internal bus in the mobile phone; providing a peripheral hub having an input that is an I/O port and at least one output that is an I/O port; operatively connecting the internal bus to the input of the peripheral hub; providing an I/O interface device controller respectively for each I/O port in the peripheral hub; storing and installing drivers for peripheral devices connected to the peripheral hub; operatively connecting at least one peripheral device to the at least one output of the peripheral hub; interworking with the internal bus of the mobile phone to exchange data and control information with a CPU of the mobile phone; and directing control and data from the internal bus of the mobile phone to a corresponding interface device controller for a respective peripheral device.

### BRIEF DESCRIPTION OF THE DRAWINGS

The accompanying figures, in which like reference numerals refer to identical or functionally-similar elements throughout the separate views and which are incorporated in and form part of the specification, further illustrate the present invention and, together with the detailed description of the invention, serve to explain the principles of the present invention.

FIG. 1 depicts a block diagram illustrative of a mobile switching center, base station and mobile phone for use with the present method and system.

FIG. 2 illustrates a detailed block diagram illustrative of the peripheral hub according to one embodiment of the present method and system.

FIG. 3 illustrates a very general flow chart of logical operational steps that may be followed in accordance with one embodiment of the present method and system.

### DETAILED DESCRIPTION

The particular values and configurations discussed in these non-limiting examples can be varied and are cited merely to illustrate an embodiment of the present invention and are not intended to limit the scope of the invention.

Methodologies of the present method and system may include at least one of: to provide external access to the internal bus of the data capable mobile phone; for an external peripheral hub that connects to the internal bus of the data capable mobile phone; for an external peripheral hub to provide at least one of standard PC peripheral connectors, PS/2 keyboard, PS/2 mouse, super VGA monitor (HD 15 PIN), parallel printer cable (IEEE 1284 cable), and USB port; for an external peripheral hub to provide drivers needed to access the devices connected to the hub, like printer driver for the printer attached; to provide means for the mobile to access the needed drivers from the hub.

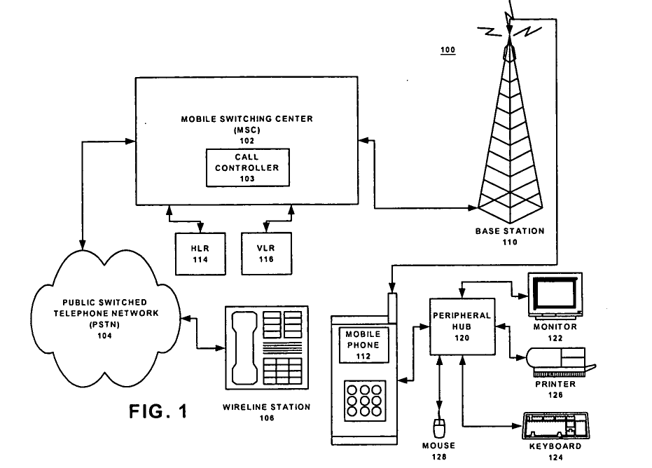

Referring to FIG. 1, a system 100 is depicted for at least one mobile terminal (also referred to as a mobile phone or mobile station) of a plurality of mobile terminals operatively connected to a communication network. Although the present system and method may be used any type of system (wired and wireless, for example), the subscriber may typically be a mobile subscriber who uses a mobile terminal (also referred to as mobile phone, a cell phone, mobile handset, car phone). The system (or communication network) 100 may have a mobile switching center (MSC) 102. The system may be, or may be part of, one or more of a telephone network, a local area network (“LAN”), the Internet, and a wireless network. In the depicted embodiment, a public switched telephone network (PSTN) 104 is connected to the MSC 102. The PSTN 104 routes calls to and from mobile users through the MSC 102. The PSTN 104 also routes calls from and to wireline stations 106. The MSC 102 may also be connected to one or more base stations (BS) 110. Each of the base stations 110 communicates with mobile terminal(s) 112 in its service area. The PSTN 104 generally can be implemented as the worldwide voice telephone network accessible to all those with telephones and access privileges (e.g., AT&T long distance network).

Each of the mobile terminals 112 may have a home location register (HLR) 114 where data about each of the mobile terminals 112 resides. Some of the mobile terminals 112 may be remotely located from their home location, and in that case, a visiting location register (VLR) 116 is set up locally for each mobile terminal 112 that is visiting in its service area. HLR 114 can be implemented as a permanent SS7 database utilized in cellular networks, such as, but not limited to, for example, AMPS (Advanced Mobile Phone System), GSM (Global System for Mobile Communications), and PCS.

HLR 114 may be utilized generally to identify/verify a subscriber, and also contains subscriber data related to features and services. HLR 114 is generally utilized not only when a call is being made within a coverage area supported by a cellular provider of record, but also to verify the legitimacy and to support subscriber features when a subscriber is away from his or her home area. VLR 116, on the other hand, may be implemented as a local database maintained by the cellular provider whose territory is being roamed. Mobile terminal 112 may be implemented as a cellular device, personal communication device, short message service device or wireless communications device (e.g., a wireless personal digital assistant).

The mobile terminal 112 may also be utilized as a computing platform by the connection of a peripheral hub 120. A plurality of peripheral devices, such as monitor 122, printer 126, keyboard 124, and mouse 128, are also connected to the peripheral hub 120. In general, a respective peripheral device of the plurality of peripheral devices may be one of: mouse, trackball, monitor, keyboard, printer, scanner, digital camera, storage device, digital video camera, joystick, speaker, audio system, video display device, microphone, etc.

The present system allows the mobile phone 112 (or other similar portable devices) to be easily and conveniently used in a non-mobile computing environment. Thus, for example, the mobile phone 112 may be used as a replacement for a desktop computer. The peripheral hub 120 allows use of the mobile phone 112 with input/output devices (such as, monitor 122, printer 126, keyboard 124, and mouse 128) that are usually considered non-portable and associated with a desktop computer system.

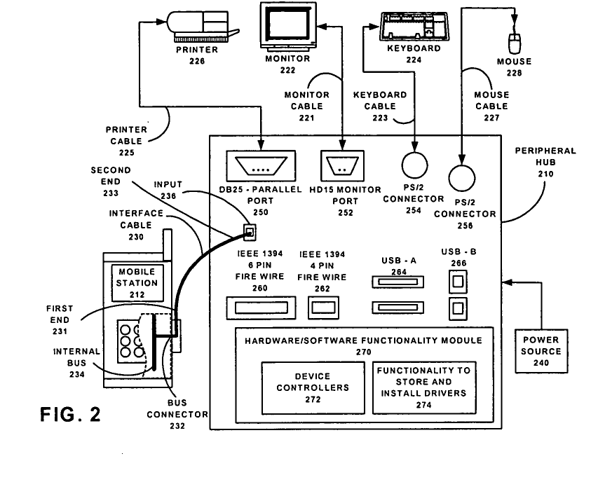

Referring to FIG. 2, a system is depicted for interfacing a data capable mobile phone 212 to a plurality of peripheral devices, such as, monitor 222, printer 226, keyboard 224, and mouse 228. The mobile phone 212 may have an a internal bus 234 that carries peripheral interfaces, and may have a bus connector 232 that is operatively connected to the internal bus 234.

A peripheral hub 210 may have an input 236 and a plurality of peripheral device outputs. In the embodiment depicted in FIG. 2, for example, the outputs may be DB25 parallel port connector 250, HD15 connector 252, six pin mini DIN (PS/2) connector 254 and 256, IEEE 1394 six pin connector 260, IEEE 1394 four pin connector 262, USB-A connector 264, and USB-B connector 266. Other types of outputs and connectors may be used with the peripheral hub 210. Also as depicted in FIG. 2, the monitor 222 is connected to the HD15 connector 252 by monitor cable 221, the printer 226 is connected to the DB25 parallel port connector 250 by printer cable 225, the keyboard 224 is connected to the PS/2 connector 254 by keyboard cable 223, and the mouse 228 is connected to the PS/2 connector 256 by mouse cable 227.

An interface cable 230 may have a first end 231 releasably connectable to the bus connector 232 and a second end 233 operatively connected to the input 236 of the peripheral hub 210. A functionality module may be operatively connected to the input 236 and to the outputs 250, 252, 254, 256, 260, 262, 264, and 266. The functionality module 270 separates at least one peripheral interface from the internal bus 234 of the mobile phone 212 and makes the at least one peripheral interface available on one of the outputs 250, 252, 254, 256, 260, 262, 264, and 266. The functionality module 270 may also have functionality to recognize peripheral devices connected to the peripheral hub. The functionality module 270 may also have device controllers 272 for the I/O ports supported by the peripheral hub. The functionality module 270 may also have functionality 274 to store and install drivers for the peripheral devices connected to the peripheral hub 210. Power may be supplied to the peripheral hub 210 by power source 240.

A mobile phone 212 may support a standard bus 234 similar to the PCI bus used by personal computers. This bus 234 may provide architecture for the external device controllers (like parallel, serial, USB port controllers) to connect and interact with the CPU inside the mobile 212. The interface cable 230 may connect the standard bus 234 inside the mobile 212 with the device controllers 272 in the peripheral hub 210.

An interface cable 230 may consist of all the connections necessary to access the data and control bus of the CPU inside the mobile. It may be very similar to the bus connectors for a laptop to the docking station with the exception that it would be a cable instead of connectors that interlock into each other. In an alternative embodiment it may also be connectors that interlock into each other.

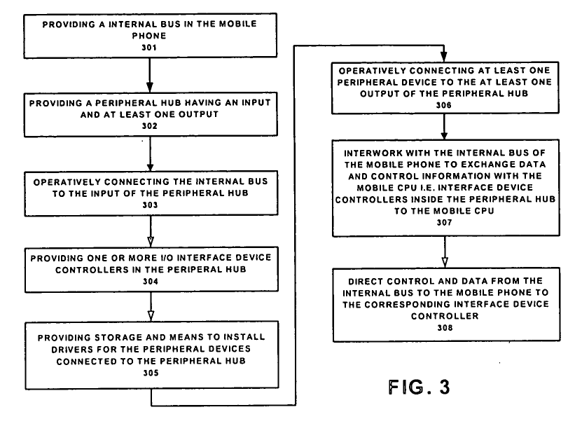

FIG. 3 is a general block diagram depicting an embodiment of the present method. In very general terms, the method has the steps of: providing a internal bus in the mobile phone (step 301); providing a peripheral hub having an input and at least one output (step 302); operatively connecting the internal bus to the input of the peripheral hub (step 303); providing one or more i/o interface device controllers inside the peripheral hub (step 304); providing storage and means to install drivers for the peripheral devices connected to the peripheral hub (step 305); operatively connecting at least one peripheral device to the at least one output of the peripheral hub (step 306); operatively inter working with the internal bus of the mobile phone to exchange data and control information with a CPU of the mobile phone to interface device controllers inside the peripheral hub to the CPU (step 307); directing control and data from the internal bus of the mobile phone to a corresponding interface device controller in the peripheral hub(step 308).

Thus the improved method and system allow data capable mobile phones to be connected to external audio/visual/data peripheral devices much like a personal computer. The present system and method may be used with non-mobile phones, as well as, other mobile devices. Also, different types of data storage devices may be used with the present method and system. For example, a data storage device may be one or more of a magnetic, electrical, optical, biological, and atomic data storage medium.

The method and system of the present invention may be implemented in hardware, software, or combinations of hardware and software. In a software embodiment, portions of the present invention may be computer program products embedded in computer readable medium. Portions of the system may employ and/or comprise a set and/or series of computer instructions written in or implemented with any of a number of programming languages, as will be appreciated by those skilled in the art.

The embodiments and examples set forth herein are presented to best explain the present invention and its practical application and to thereby enable those skilled in the art to make and utilize the invention. Those skilled in the art, however, will recognize that the foregoing description and examples have been presented for the purpose of illustration and example only. Other variations and modifications of the present invention will be apparent to those of skill in the art, and it is the intent of the appended claims that such variations and modifications be covered. The description as set forth is not intended to be exhaustive or to limit the scope of the invention. Many modifications and variations are possible in light of the above teaching without departing from the scope of the following claims. It is contemplated that the use of the present invention can involve components having different characteristics. It is intended that the scope of the present invention be defined by the claims appended hereto, giving full cognizance to equivalents in all respects.

1. A system for interfacing a data capable mobile phone to peripheral devices, comprising:
an internal bus in the mobile phone;
a peripheral hub operatively connected to the internal bus, the peripheral hub having I/O ports;
a plurality of peripheral devices operatively connected to the I/O ports of the peripheral hub;
device controllers in the peripheral hub for respectively the I/O ports; and
the peripheral hub respectively functionally coupling the peripheral devices to the mobile phone.

2. The system according to claim 1, wherein the peripheral hub further comprises:
an input operatively connectable to the internal bus of the mobile phone;
at least one peripheral device output that is an I/O port; and
a functionality module having I/O interface device controllers for the I/O ports operatively connected to the input and to the at least one output, the functionality module separating peripheral interfaces from the internal bus of the mobile phone and making respective peripheral interfaces available on respective outputs of the peripheral hub.

3. The system according to claim 2, wherein the peripheral hub has a plurality of peripheral device outputs, and wherein a respective peripheral device output of the plurality of peripheral device outputs is one of; DB25 parallel port connector, HD15 connector, six pin mini DIN (PS/2) connector, IEEE 1394 six pin connector, IEEE 1394 four pin connector, USB-A connector, and USB-B connector.

4. The system according to claim 1, wherein the functionality module further comprises functionality to recognize peripheral devices connected to the peripheral hub.

5. The system according to claim 1, wherein the a plurality of peripheral devices are operatively connected to the peripheral hub, and wherein a respective peripheral device of the plurality of peripheral devices is one of: mouse, trackball, monitor, keyboard, printer, scanner, digital camera, storage device, digital video camera, joystick, speaker, audio system, video display device, and microphone.

6. A peripheral hub for interfacing a data capable mobile phone to at least one peripheral device, comprising:
an input that is an I/O port operatively connectable to an internal bus of the mobile phone;
at least one peripheral device output that is an I/O port;
a functionality module operatively connected to the input and to the at least one peripheral device output, the functionality module having I/O interface device controllers for the I/O ports;
wherein the functionality module separates at least one peripheral interface from the internal bus of the mobile phone and makes the at least one peripheral interface available on the at least one output.

7. The system according to claim 6, wherein the peripheral hub has a plurality of peripheral device outputs, and wherein a respective peripheral device output of the plurality of peripheral device outputs is one of; DB25 parallel port connector, HD15 connector, six pin mini DIN (PS/2) connector, IEEE 1394 six pin connector, IEEE 1394 four pin connector, USB-A connector, and USB-B connector.

8. The system according to claim 6, wherein the functionality module further comprises functionality to recognize peripheral devices connected to the peripheral hub.

9. A system for interfacing a data capable mobile phone to at least one peripheral device, comprising:
an internal bus in the mobile phone;
a bus connector on the mobile phone, the bus connector operatively connected to the internal bus;
a peripheral hub having an input that is an I/O port and at least one output that is an I/O port;
an interface cable having a first end releasably connectable to the bus connector and a second end operatively connected to the input of the peripheral hub;
at least one peripheral device releasably connectable to the at least one output of the peripheral hub; and
a functionality module operatively connected to the input and to the at least one output, the functionality module having I/O interface device controllers separating at least one peripheral interface from the internal bus of the mobile phone and making the at least one peripheral interface available on the at least one output.

10. The system according to claim 9, wherein the peripheral hub has a plurality of peripheral device outputs, and wherein a respective peripheral device output of the plurality of peripheral device outputs is one of; DB25 parallel port connector, HD15 connector, six pin mini DIN (PS/2) connector, IEEE 1394 six pin connector, IEEE 1394 four pin connector, USB-A connector, and USB-B connector.

11. The system according to claim 9, wherein the functionality module further comprises functionality to recognize peripheral devices connected to the peripheral hub.

12. The system according to claim 9, wherein a plurality of peripheral devices are operatively connected to the peripheral hub, and wherein a respective peripheral device of the plurality of peripheral devices is one of: mouse, trackball, monitor, keyboard, printer, scanner, digital camera, storage device, digital video camera, joystick, speaker, audio system, video display device, and microphone.

13. A method for interfacing a data capable mobile phone to at least one peripheral device, comprising:
providing a internal bus in the mobile phone;
providing a peripheral hub having an input that is an I/O port and at least one output that is an I/O port;
operatively connecting the internal bus to the input of the peripheral hub;
providing an I/O interface device controller respectively for each I/O port in the peripheral hub;
storing and installing drivers for peripheral devices connected to the peripheral hub;
operatively connecting at least one peripheral device to the at least one output of the peripheral hub;
interworking with the internal bus of the mobile phone to exchange data and control information with a CPU of the mobile phone; and
directing control and data from the internal bus of the mobile phone to a corresponding interface device controller for a respective peripheral device.

14. The method according to claim 13, wherein the peripheral hub has a plurality of peripheral device outputs, and wherein a respective peripheral device output of the plurality of peripheral device outputs is one of; DB25 parallel port connector, HD15 connector, six pin mini DIN (PS/2) connector, IEEE 1394 six pin connector, IEEE 1394 four pin connector, USB-A connector, and USB-B connector.

15. The method according to claim 13, wherein the method further comprises recognizing peripheral devices connected to the peripheral hub.

16. The system according to claim 13, wherein a plurality of peripheral devices are operatively connected to the peripheral hub, and wherein a respective peripheral device of the plurality of peripheral devices is one of: mouse, trackball, monitor, keyboard, printer, scanner, digital camera, storage device, digital video camera, joystick, speaker, audio system, video display device, and microphone.
